(19) United States
(12) Patent Application Publication
(10) Pub. No.: US 2013/0149496 A1
(43) Pub. Date: Jun. 13, 2013

(54) FINGERPRINT-RESISTANT ARTICLES AND METHODS FOR MAKING AND USING SAME

(71) Applicants: Prantik Mazumder, Ithaca, NY (US); Valerio Pruneri, Castelldefels (ES); Mark Alejandro Quesada, Horseheads, NY (US); Wageesha Senaratne, Horseheads, NY (US); Lili Tian, Corning, NY (US)

(72) Inventors: Prantik Mazumder, Ithaca, NY (US); Valerio Pruneri, Castelldefels (ES); Mark Alejandro Quesada, Horseheads, NY (US); Wageesha Senaratne, Horseheads, NY (US); Lili Tian, Corning, NY (US)

(21) Appl. No.: 13/693,379

(22) Filed: Dec. 4, 2012

Related U.S. Application Data
(60) Provisional application No. 61/568,971, filed on Dec. 9, 2011.

(51) Int. Cl. C09D 7/12

(52) U.S. Cl. CPC C09D 7/1258
USPC 428/143; 427/265

(57) ABSTRACT

Described herein are various methods for making textured articles, textured articles that have improved fingerprint resistance, and methods of using the textured articles. The textured articles generally include a substrate and at least two different sets of nanostructured topographical features that are created in or on a surface of the substrate. Each set of nanostructured topographical features will have at least one average dimensional attribute that is different from that of any other set of nanostructured topographical features.

### CROSS-REFERENCE TO RELATED APPLICATIONS

This application claims the benefit of priority under 35 U.S.C. §119 of U.S. Provisional Patent Application Ser. No. 61/568,971 filed on Dec. 9, 2011 the contents of which are relied upon and incorporated herein by reference in their entirety as if fully set forth below.

### TECHNICAL FIELD

The present disclosure relates generally to textured surfaces. More particularly, the various embodiments described herein relate to articles having nanoscale texturing such that the textured articles exhibit improved fingerprint resistance, as well as to methods of making and using the textured articles.

### BACKGROUND

Touch-sensitive devices, such as touch screen surfaces (e.g., surfaces of electronic devices having user-interactive capabilities that are activated by touching specific portions of the surfaces), have become increasingly more prevalent. In general, these surfaces should exhibit high optical transmission, low haze, high durability, and low reflectivity, among other features. As the extent to which the touch screen-based interactions between a user and a device increases, so too does the likelihood that fingerprint or other undesirable residue can adversely affect the touch screen surface.

Fingerprint residue (e.g., natural fingerprint oil or grease, fingerborne oil or grease, and any other contaminants, such as dirt, cosmetics, hand creams/lotions, or the like, coupled therewith) can render a touch screen or any other aesthetic or functional surface unsightly, less user-friendly, and/or less functional. Further, an accumulation of such residue can lead to a distortion in the transmission, haze, and/or reflection properties of the touch screen surface. That is, as a user contacts and operates the touch screen surface, fingerprint residue is transferred to the surface. When a fingerprint residue-rich region of the surface is subsequently manipulated, the fingerprint residue can smudge or smear across the surface. These smudges and smear marks are visible to the naked eye, and can affect how an image from the touch screen surface is observed by a user. With significant build-up, in some cases, these smudges and smear marks can interfere with the function of a device by obscuring objects that must be seen for use and/or transmission of information into or from the device.

To combat the deleterious effects of fingerprint residue transfer (or other undesirable residue transfer), numerous so-called “anti-fingerprint” or “fingerprint-resistant” technologies have been developed. These technologies generally involve making a modification to the touch screen surface (e.g., texturing the surface) and/or applying a coating or film to the touch screen surface to render the surface both hydrophobic and oleophobic. The aim of such approaches is towards preventing the transfer of fingerprint residue in the first place, while also enabling easy removal of any residue that ultimately is transferred.

Unfortunately, while these approaches may improve the fingerprint resistance of some touch screen or other surfaces, the improvements generally are at the expense of other features. For example, certain hydrophobic and oleophobic coating materials can cause a decrease in transmission, an increase in haze, an increase in reflection, and/or a decrease in scratch resistance relative to the uncoated touch screen surface. In other cases, the improvement can come at the expense of processing time, complexity, and/or cost.

There accordingly remains a need for technologies that provide touch screen and other aesthetic or functional surfaces with improved resistance against the adverse effects of fingerprint or other undesirable residue. It would be particularly advantageous if such technologies did not adversely affect other desirable properties of the surfaces (e.g., transmission, haze, reflection, durability, scratch resistance, and the like) and/or significantly increase the time, complexity, and/or cost required to make such surfaces. It is to the provision of such technologies that the present disclosure is directed.

### BRIEF SUMMARY

Described herein are various methods for making textured articles, textured articles that have improved fingerprint resistance, and methods of using the textured articles.

One type of textured article includes a substrate, a first set of nanostructured topographical features disposed on or created in a surface of the substrate, and a second set of nanostructured topographical features disposed on the first set of nanostructured topographical features and/or on the surface of the substrate. The first set of nanostructured topographical features can have at least one dimensional attribute different than the second set of nanostructured topographical features. The dimensional attribute can be an average height, an average lateral cross-sectional dimension, and/or an average volume.

In certain implementations, the textured article can comprise a portion of a touch-sensitive display screen or cover plate for an electronic device, a non-touch-sensitive component of an electronic device, a surface of a household appliance, or a surface of a vehicle component.

One type of method of forming a textured article includes providing a substrate, disposing and/or creating a first set of nanostructured topographical features on and/or in a surface of the substrate, and disposing a second set of nanostructured topographical features on the first set of nanostructured topographical features and/or on the surface of the substrate. The first set of nanostructured topographical features can have at least one dimensional attribute different than the second set of nanostructured topographical features. In certain cases, disposing a second set of nanostructured topographical features on the first set of nanostructured topographical features and/or on the surface of the substrate comprises glancing angle deposition of the second set of nanostructured topographical features.

It is to be understood that both the foregoing brief summary and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIGS. 1a-f are schematic cross-sectional illustrations of textured articles having surfaces with at least two different nanostructured topographical features.

FIG. 2 is a schematic illustration of a glancing angle deposition (GLAD) apparatus in accordance with EXAMPLE 1.

FIG. 3 is a scanning electron microscope (SEM) image of a region of a surface of a GLAD-coated sample in accordance with EXAMPLE 1.

FIG. 4 is an SEM image of a region of a surface of a GLAD-coated sample in accordance with EXAMPLE 1.

These and other aspects, advantages, and salient features will become apparent from the following detailed description, the accompanying drawings, and the appended claims.

### DETAILED DESCRIPTION

Referring now to the figures, wherein like reference numerals represent like parts throughout the several views, exemplary embodiments will be described in detail. Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Provided herein are various textured articles that have improved fingerprint resistance, methods for making the textured articles, and methods of using the textured articles. The methods and articles generally include the use of at least two different sets of nanostructured topographical features that are created in or on the surface of the article substrate. These groups of different nanostructured topographical features can render the surfaces hydrophobic and oleophobic, thereby beneficially providing the articles with improved fingerprint resistance relative to similar or identical articles that lack the texturing. In addition, and as will be described in more detail below, the textured articles can exhibit high transmission, low haze, low reflectivity, and high durability, among other features.

As used herein, the terms “anti-fingerprint,” “fingerprint resistance,” or “fingerprint-resistant” refer to the ability of a surface to resist the visible transfer of residue from tactile interactions with a user; the non-wetting properties of a surface with respect to such tactilely-transferable residue; the minimization, hiding, or obscuring of tactilely-transferable residue on a surface; and combinations thereof. An anti-fingerprint or fingerprint-resistant surface must therefore be resistant to both water and oil transfer when tactilely contacted by a user. Stated another way, an anti-fingerprint or fingerprint-resistant surface must be both hydrophobic and oleophobic.

In addition, the term “oleophobic” is used herein to refer to a material that imparts a wetting characteristic such that the contact angle between oleic acid and a surface formed from the material is greater than 90 degrees (°). Analogously, the term “hydrophobic” is used herein to refer to a material that imparts a wetting characteristic such that the contact angle between water and a surface formed from the material is greater than 90°.

Further, the term “tactilely-transferable residue” is used herein for convenience to generically refer to and encompass any undesirable residue that is contacted with a surface by a given user. This includes natural human-oils or grease, as well as any other materials coupled therewith (e.g., dirt, cosmetics, food particles, hand creams/lotions, or the like) that are contacted with the surface via a finger, palm, wrist, forearm/elbow (e.g., when an appliance door is closed or otherwise manipulated by a forearm or an elbow), or other body part.

As stated above, the textured articles generally include a substrate and at least two different sets of nanostructured topographical features that are created in or on a surface of the substrate. Each set of nanostructured topographical features will have at least one average dimensional attribute that is different from that of any other set of nanostructured topographical features. The dimensional attributes that can be different include volume, height, and/or lateral cross-sectional dimension. As used herein, the term “lateral cross-sectional dimension” refers to the longest particular dimension of an object in a cross-section of that object that is parallel to the surface of the substrate. Thus, to clarify, when a nanostructured topographical feature is circular in cross-section, the longest lateral cross-sectional dimension is its diameter; when a nanostructured topographical feature is oval-shaped in cross-section, the longest lateral cross-sectional dimension is the longest diameter of the oval; and when a nanostructured topographical feature has an irregularly-shaped cross-section, the longest lateral cross-sectional dimension is the line between the two farthest opposing points on the perimeter of the island.

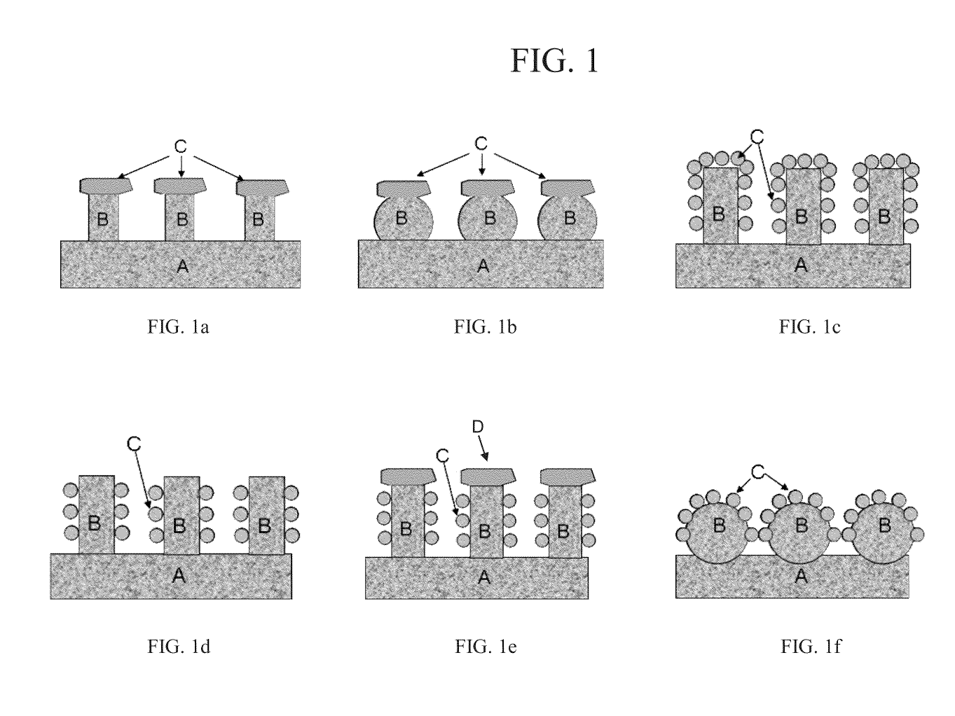

FIG. 1 provides various schematic cross-sectional illustrations of such textured articles. In each of the schematic illustrations of FIG. 1, the substrate is designated by the reference character “A,” a first or primary set of nanostructured topographical features is designated by reference character “B,” and a second or secondary set of nanostructured topographical features is designated by reference character “C.”

The textured article shown in FIG. 1a has a so-called “overhang” structure, where the primary set of nanostructured topographical features includes nanostructured pillars or protrusions, and the secondary set of nanostructured topographical features includes an added mass disposed on the nanostructured pillars or protrusions. This nail-like overhang structure has a re-entrant geometry, which is beneficial for providing oleophobicity. As can be seen in FIG. 1a, the two sets of nanostructured topographical features have different average volumes (i.e., the average volume of the overhanging added masses is different from the average volume of the pillars or protrusions), average heights (i.e., the average height of the overhanging added masses is different from the average height of the pillars or protrusions), and average lateral cross-sectional dimensions (the average width of the overhanging added masses is different from the average width of the pillars or protrusions).

The textured article shown in FIG. 1b also has an overhang structure, where the primary set of nanostructured topographical features includes nanoparticles, and the secondary set of nanostructured topographical features includes an added mass disposed on the nanoparticles. This overhang structure also has a re-entrant geometry, which is beneficial for providing oleophobicity. As can be seen in FIG. 1b, the two sets of nanostructured topographical features have different average volumes and average heights.

The textured article shown in FIG. 1c has a so-called “hierarchical” structure, where the primary set of nanostructured topographical features includes nanostructured pillars or protrusions, and the secondary set of nanostructured topographical features includes nanoparticles. The hierarchical nature of this structure is beneficial for providing oleophobicity. As can be seen in FIG. 1c, the two sets of nanostructured topographical features have different average volumes, average heights, and average lateral cross-sectional dimensions.

The textured article shown in FIG. 1d is identical to the textured article shown in FIG. 1c, with the exception that the nanostructured pillars or protrusions of the primary set of nanostructured topographical features do not have any nanoparticles of the secondary set of nanostructured topographical features on the top surface thereof. One benefit of keeping the top surfaces free of any secondary nanostructured topographical features is to minimize dislodging of the particles during tactile interaction with the textured article.

The textured article shown in FIG. 1e includes three sets of nanostructured topographical features, with the third or tertiary set of nanostructured topographical features being designated by reference character “D.” This structure is effectively a hybridized structure that includes aspects of the textured article of FIG. 1a and FIG. 1d. As can be seen in FIG. 1e, the three sets of nanostructured topographical features all have different average volumes, average heights, and average lateral cross-sectional dimensions from each other.

The textured article shown in FIG. 1f has a hierarchical structure, where both sets of nanostructured topographical features include nanoparticles. The hierarchical nature of this structure is beneficial for providing oleophobicity. As can be seen in FIG. 1f, the two sets of nanostructured topographical features have different average volumes, average heights, and average lateral cross-sectional dimensions.

It should be noted that the various nanostructured topographical features shown in the schematic illustrations of FIG. 1 are merely illustrative of the types of features that can be implemented in the textured articles described herein. Those skilled in the art to which this disclosure pertains will recognize that a variety of other shaped features can be used, including pyramids, cylinders, helices, tapered cylinders, toroids, and the like. Similarly, the relative sizes of the dimensional attributes of the various nanostructured topographical features shown in FIG. 1 are merely illustrative the relative size scales that can be implemented in the textured articles described herein. Those skilled in the art to which this disclosure pertains will recognize that the dimensional attributes can be varied from those shown in FIG. 1, to include situations where the average volumes, average heights, and/or average lateral cross-sectional dimensions of the secondary, tertiary, quaternary, and so on sets of nanostructured topographical features are larger than those of the primary set of nanostructured topographical features. Additionally, while the various schematic illustrations of FIG. 1 depict the second and third sets of nanostructured topographical features disposed on only the first set of nanostructured topographical features, and only the first set of nanostructured topographical features disposed on the substrate, it is possible for any of the sets set of nanostructured topographical features to be disposed on the substrate and/or on each other.

The methods of making the textured articles generally involve the steps of providing a substrate material, followed by disposing and/or creating at least two sets of nanostructured topographical features on and/or in the surface of the substrate.

Provision of the substrate first involves selection of an appropriate material for use as the substrate. This choice will be made based on the particular use of the textured article. In general, however, a variety of substrates can be used. For example, the substrate can be a glass material, a glass-ceramic material, a ceramic material, a polymeric material, or the like.

By way of illustration, with respect to glasses, the material chosen can be any of a wide range of silicate, borosilicate, aluminosilicate, or boroaluminosilicate glass compositions, which optionally can comprise one or more alkali and/or alkaline earth modifiers. One such glass composition includes the following constituents: 58-72 mole percent (mol %) SiO₂; 9-17 mol % Al₂O₃; 2-12 mol % B₂O₃; 8-16 mol % Na₂O; and 0-4 mol % K₂O, wherein the ratio

$$\frac{A {l}_{2} {O}_{3} ( mol \% ) + {B}_{2} {O}_{3} ( mol \% ) }{\sum modifiers ( mol \% )} > 1 ,$$

where the modifiers comprise alkali metal oxides. Another glass composition includes the following constituents: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. Yet another illustrative glass composition includes the following constituents: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 parts per million (ppm) As₂O₃; and less than 50 ppm Sb₂O₃; wherein 12 mol %≦Li₂O+Na₂O+K₂O≦20 mol %, and 0 mol %≦MgO+CaO≦10 mol %. Still another illustrative glass composition includes the following constituents: 55-75 mol % SiO₂, 8-15 mol % Al₂O₃, 10-20 mol % B₂O₃; 0-8% MgO, 0-8 mol % CaO, 0-8 mol % SrO, and 0-8 mol % BaO.

Similarly, with respect to glass-ceramics, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

If the substrate is formed from a ceramic material, it can be any of a variety of oxides, carbides, nitrides, oxycarbides, carbonitrides, or the like, whether in polycrystalline or single crystal form. One such ceramic is polycrystalline Al₂O₃. Another illustrative ceramic is polycrystalline SiC. Yet another illustrative ceramic material is single-crystal GaAs (e.g., as used in the fabrication of certain semiconductor devices).

If the substrate is formed from a polymer material, it can be chosen from a variety of thermosetting or thermoplastic materials, including those that are polyamides, polyesters, polyimides, polysulfones, polycarbonates, polyurethanes, polyurethane-ureas, polyolefins, phenols, epoxies, polyacrylates, polymethylacrylates, polystyrenes, polyhydroxy acids, polyanhydrides, polyorthoesters, polyphosphazenes, polyphosphates, copolymers thereof, blends thereof, or the like.

Regardless of the material chosen therefor, the substrate can adopt a variety of physical forms. That is, from a cross-sectional perspective, the substrate can be flat or planar, or it can be curved and/or sharply-bent. Similarly, it can be a single unitary object, or a multi-layered structure or laminate.

In certain situations, the substrate can be subjected to an optional treatment prior to disposing the at least two sets of nanostructured topographical features on the surface of the substrate. Examples of such treatments include physical or chemical cleaning, physical or chemical strengthening (e.g., by thermal tempering, chemical ion-exchange, or like processes in the case of a glass), physical or chemical etching, physical or chemical polishing, annealing, sintering, shaping, and/or the like. Such processes are known to those skilled in the art to which this disclosure pertains.

Once the substrate has been selected and/or prepared, each set of nanostructured topographical features can be disposed thereon or created therein. Before the first set of nanostructured topographical features can be disposed on or created in the surface of the substrate, the materials used for the particular set of nanostructured topographical features should be selected. As with the substrates, a variety of materials can be used. If a given set of nanostructured topographical features will be created in the surface of the substrate, then the material chosen will be that of the substrate itself. If, however, the set of nanostructured topographical features will be disposed on the surface of the substrate, the material used to make the set of nanostructured topographical features can be the same as, or different than, that of the substrate. For example, the material can be a glass material, a glass-ceramic material, a ceramic material, a polymeric material, a metal or metalloid in elemental form (e.g., any of the transition metals, Si, Ge, As, or the like), an alloy, or the like. With the exception of elemental metals or metalloids, and alloys, such materials can be chosen from those described above.

A variety of techniques can be used to dispose the sets of nanostructured topographical features on the surface of the substrate. By way of example, each set of nanostructured topographical features independently can be fabricated using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, glancing angle deposition (GLAD), and the like), atomic layer deposition, spray coating, spin-coating, dip-coating, inkjetting, sol-gel processing, or the like. Such processes are known to those skilled in the art to which this disclosure pertains.

Similarly, a variety of techniques can be used to create the sets of nanostructured topographical features in the surface of the substrate. By way of example, these include mechanical attrition of portions of the surface, chemical or physical etching of portions of the surface with or without a mask, mechanically embossing portions of the surface, or the like. Such processes are known to those skilled in the art to which this disclosure pertains.

Given the breadth of potential uses for the textured articles described herein, it should be understood that the specific features or properties of a textured article will depend on the ultimate application therefor or use thereof. The following description, however, will provide some general considerations.

In general, the average height for each set of nano structured topographical features will be less than or equal to about 550 nm. If the textured article is to be used in applications where it may be desirable to optimize texturing for reflectivity, durability, weight, or cost characteristics (e.g., in electronic devices, or the like), then even shorter nanostructured topographical features (e.g., about 50 nm to about 300 mm) can be used. By way of example, if the textured article is intended to function as a cover for a touch screen display to provide improved fingerprint resistance and improved reflection-resistance, then the average height of the nanostructured topographical features of each set of nanostructured topographical features can be less than or equal to about 200 nm.

The average lateral cross-sectional dimension of each set of nanostructured topographical features should be less than or equal to about 550 nm. In some situations, the average lateral cross-sectional dimension of the nanostructured topographical features of each set can be about 10 nm to about 300 nm. In situations where even smaller texture features are desirable, the average lateral cross-sectional dimension of the nanostructured topographical features of each set can be less than or equal to about 150 nm.

Further, the area fraction of the substrate that is covered by the sets of nanostructured topographical features should be less than or equal to about 0.5. In certain situations, the area fraction of the substrate that is covered by the sets of nanostructured topographical features can be about 0.10 to about 0.25.

The ratio of the distance between two adjacent topographical features of a given set of nanostructured topographical features to the average lateral cross-sectional dimension for that set of nanostructured topographical features should be less than or equal to about 5:1. In certain situations, this ratio can be about 1:1 to about 3:1.

In general, the optical transmittance of the textured article will depend on the type of materials chosen. For example, certain textured articles can have a transparency over the entire visible spectrum of at least about 85%. In certain cases where the textured article is used in the construction of a touch screen for an electronic device, for example, the transparency of the textured article can be at least about 92% over the visible spectrum. In situations where the substrate comprises a pigment (or is not colorless by virtue of its material constituents), the transparency can diminish, even to the point of being opaque across the visible spectrum. Thus, there is no particular limitation on the optical transmittance of the textured article itself.

Like transmittance, the haze of the textured article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the textured article is used in the construction of a touch screen for an electronic device, the haze of the coated article can be less than or equal to about 5%.

Regardless of the application or use, the textured articles described herein offer improved fingerprint resistance relative to identical articles that lack the texturing described herein. While fingerprint resistance can appear to be a qualitative and potentially subjective characterization, there are a number of quantifiable indications of fingerprint-resistance, examples of which will now be described.

One quantifiable indication of this improved fingerprint resistance can be seen in the amount of tactilely-transferable residue that is actually transferred from a user to the article during use. That is, when a user tactilely interacts with the textured article, some amount of tactilely-transferable residue can transfer to the article. The mass of the tactilely-transferable residue on the textured article after each interaction can be quantified, for example, by weighing the mass thereof. In most situations, the amount of tactilely-transferable residue that is actually transferred from a user to the textured article is less than or equal to about 1 milligram (mg) per tactile contact or interaction. In some implementations, less than or equal to about 0.02 mg per tactile contact of such materials is transferred, while in other implementations, less than or equal to about 0.01 mg per tactile interaction of such materials is transferred.

Another quantifiable indication of the improved fingerprint resistance can be seen in the contact angles between the textured article and water and/or oleic acid (i.e., the hydrophobicity and/or the oleophobicity, respectively). In general, the textured articles described herein are hydrophobic and oleophobic. In some implementations, however, the contact angle between the textured article and water can be at least about 135°, and the contact angle between the textured article and oleic acid can be at least about 100°. In other implementations, these contact angles can be at least about 150° and at least about 115°, respectively.

In a specific embodiment, which may be particularly advantageous for applications such as touch sensitive electronic devices, a fingerprint-resistant textured article is formed using a chemically strengthened (ion exchanged) alkali aluminosilicate flat glass sheet as the substrate. The method for making such a fingerprint-resistant textured article involves preparing a mask on the surface of the alkali aluminosilicate flat glass substrate by dewetting a continuous ultra-thin metal film or film stack, followed by dry etching the mask-covered alkali aluminosilicate flat glass substrate to create a first set of nanostructured topographical features within the alkali aluminosilicate flat glass substrate. That is, the nanostructured topographical features are created by etching portions of the alkali aluminosilicate flat glass substrate. The first set of nanostructured topographical features comprises pillar-like structures. Such a procedure is described in more detail in U.S. Provisional Patent Application Ser. No. 61/565,188, the contents of which are incorporated herein by reference in their entirety as if fully set forth below.

If the second set of nanostructured topographical features is fabricated using glancing angle deposition (GLAD), the second set of nanostructured topographical features will appear as an overhanging additional mass (e.g., as shown in FIG. 1a). If, however, the second set of nanostructured topographical features is fabricated by dip coating into a bath containing a plurality of nanoparticles, then the second set of nanostructured topographical features will appear as nanoparticles (e.g., as shown in FIG. 1c).

Such a textured article can be used in the fabrication of a touch screen display for an electronic device. The average height of the features of the first set nanostructured topographical features can be less than or equal to about 200 nm. The average lateral cross-sectional dimension of the features of the first set nanostructured topographical features textured features can be less than or equal to about 150 nm. The average height of the features of the second set nanostructured topographical features can be less than or equal to about 100 nm. The average lateral cross-sectional dimension of the features of the second set nanostructured topographical features textured features can be less than or equal to about 250 nm. The area fraction of the substrate that is covered by the sets of nanostructured topographical features can be less than or equal to about 0.20. The textured article can have an optical transmittance of at least about 94% and a haze of less than 3%. The amount of tactilely-transferable residue that is actually transferred from a user to the textured article can be less than or equal to about 0.5 mg per tactile contact or interaction. Finally, the contact angle between the textured article and water can be at least about 140°, and the contact angle between the textured article and oleic acid can be at least about 110°.

In another specific embodiment, a fingerprint-resistant textured article is formed using a chemically strengthened (ion exchanged) alkali aluminosilicate flat glass sheet as the substrate. The method for making such a fingerprint-resistant textured article involves dipping alkali aluminosilicate flat glass substrate into a solution comprising a plurality of nanoparticles of polystyrene latex and spin-coating to create a first set of nanostructured topographical features on the surface of the alkali aluminosilicate flat glass substrate. The first set of nanostructured topographical features comprises spherical or ovular structures.

If the second set of nanostructured topographical features is fabricated using glancing angle deposition (GLAD), the second set of nanostructured topographical features will appear as an overhanging additional mass (e.g., as shown in FIG. 1b). If, however, the second set of nanostructured topographical features is fabricated by dip coating into a bath containing a plurality of different size nanoparticles, then the second set of nanostructured topographical features will appear as nanoparticles (e.g., as shown in FIG. 10.

Such a textured article can be used in the fabrication of a touch screen display for an electronic device. The average height of the features of the first set nanostructured topographical features can be less than or equal to about 520 nm. The average lateral cross-sectional dimension of the features of the first set nanostructured topographical features textured features can be less than or equal to about 520 nm. The average height of the features of the second set nanostructured topographical features can be less than or equal to about 100 nm. The average lateral cross-sectional dimension of the features of the second set nanostructured topographical features textured features can be less than or equal to about 250 nm. The area fraction of the substrate that is covered by the sets of nanostructured topographical features can be less than or equal to about 0.25. The textured article can have an optical transmittance of at least about 94% and a haze of less than 3%. The amount of tactilely-transferable residue that is actually transferred from a user to the textured article can be less than or equal to about 0.5 mg per tactile contact or interaction. Finally, the contact angle between the textured article and water can be at least about 140°, and the contact angle between the textured article and oleic acid can be at least about 110°.

The various embodiments of the present disclosure are further illustrated by the following non-limiting examples.

### EXAMPLES

### Example 1

### Glancing Angle Deposition of Oxide Coatings

In this example, GLAD was performed on a variety of substrates having a first set of nanostructured topographical features to produce a second set of nanostructured topographical features.

The substrates chosen were non-strengthened flat Corning GORILLA® Glass sheets having a nominal composition of 69.2 mol % SiO₂, 8.5 mol % Al₂O₃, 13.9 mol % Na₂O, 1.2 mol % K₂O, 6.5 mol % MgO, 0.5 mol % CaO, and 0.2 mol % SnO₂.

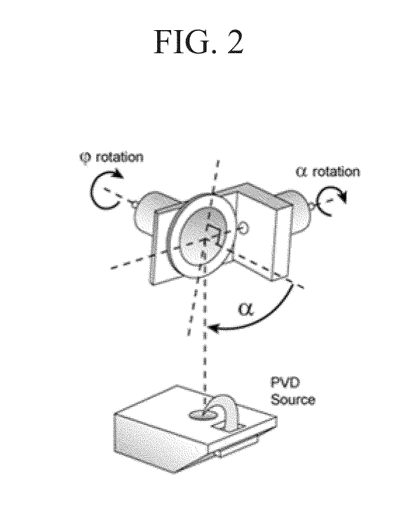

A GLAD evaporation apparatus with a platen sample holder pitched at an oblique angle producing a classic “shadow-masking” condition was fabricated. This arrangement between the obliquely-landing evaporation material and the substrate having the first set of nanostructured topographical features, comprising either a pillar structure or particles, is shown in FIG. 2.

While the glancing angle could be varied from 0° to 90°, the angle used in this was about 8.5°. The substrate platen was configured to enable discrete or continuous rotation of the sample during deposition in vacuum. The evaporation distance from boat to sample was about 10 inches. Either SnO₂ or SiO shot (Cerac, USA) was placed in the evaporation boat and the chamber was then pumped to a pressure of about 10⁻⁷ Torr. Power was delivered to the boat, resistively heating the evaporation material until a deposition rate of 10 Angstroms per second (\acute{Å}/s) was achieved. A shutter was then activated exposing the sample, obliquely pitched at 8.5°, to the evaporating material. A fixed amount of material was evaporated on one side of the substrate with the pillars or particles followed by a quick 90° rotation to deliver another equivalent fixed amount of material. In this way, all sides of the sample were efficiently coated. The deposition was terminated, and the vacuum chamber was opened. The fixed amount of material to deposit per side was chosen typically by dividing the measured average peak to peak distance between the features of the first set of nanostructured topographical features by three. Slight deviations from this did not appear to have significant effect.

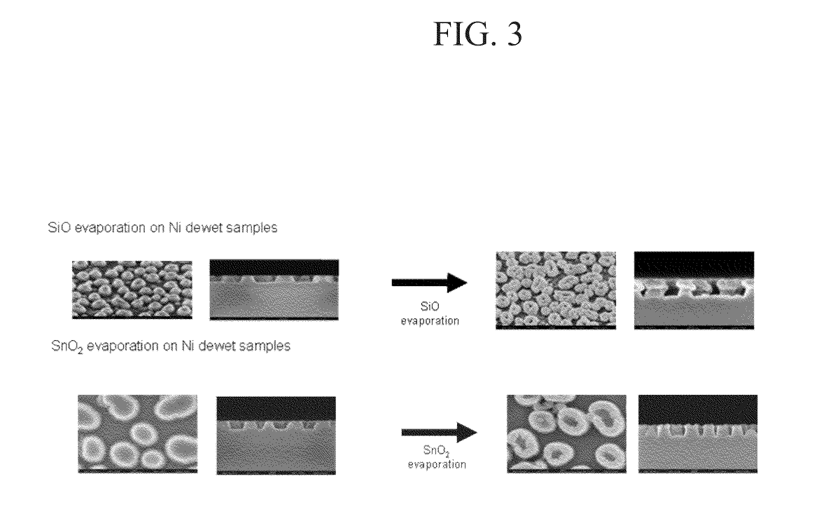

FIG. 3 provides various SEM images of samples produced using this technique on pillar-shaped structures. The net effect can be seen by observing the transformation of the “mesa”-like morphology of the left column SEM images, with the right column “mushroom” (SiO) or “lip-like” (SnO2) SEM images.

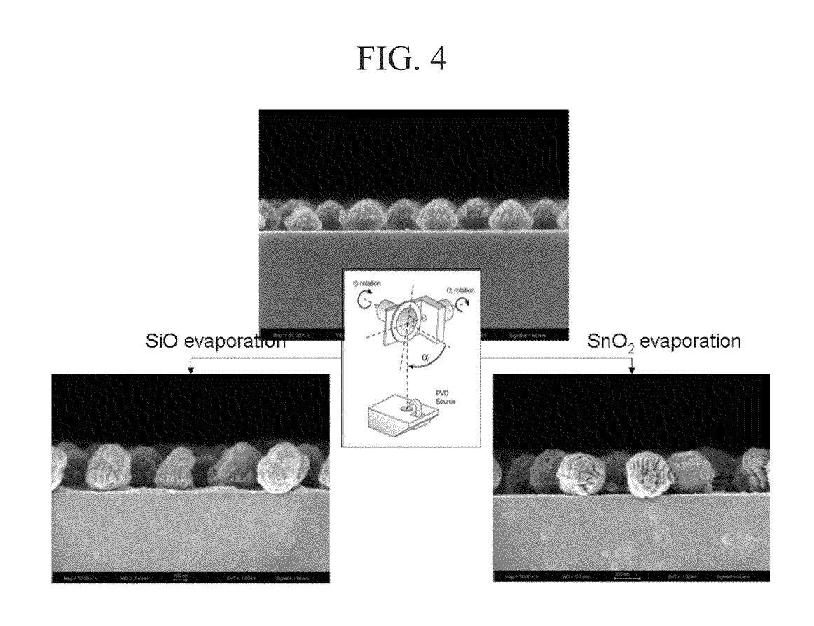

Similarly, FIG. 4 provides various SEM images of samples produced using this technique on spherical-shaped structures (nanoparticles). As can be see, the particles exhibited increased texturing after the GLAD process.

What is claimed is:

1. A textured article, comprising:
a substrate;
a first set of nanostructured topographical features disposed on or created in a surface of the substrate;
a second set of nanostructured topographical features disposed on the first set of nanostructured topographical features and/or on the surface of the substrate; and
wherein the first set of nanostructured topographical features has at least one dimensional attribute different than the second set of nanostructured topographical features.

2. The textured article of claim 1, wherein the dimensional attribute is an average height, an average lateral cross-sectional dimension, and/or an average volume.

3. The textured article of claim 1, wherein the substrate comprises a silicate glass, borosilicate glass, aluminosilicate glass, or boroaluminosilicate glass, and optionally comprises an alkali or alkaline earth modifier.

4. The textured article of claim 1, wherein the substrate is a glass-ceramic comprising a glassy phase and a ceramic phase, wherein the ceramic phase comprises β-spodumene, β-quartz, nepheline, kalsilite, or carnegieite.

5. The textured article of claim 1, wherein the substrate has an average thickness of about 0.02 millimeters to about 2 millimeters.

6. The textured article of claim 1, wherein the first set of nanostructured topographical features comprises a plurality of pillar-like structures.

7. The textured article of claim 1, wherein the first set of nanostructured topographical features comprises a plurality of nanoparticles.

8. The textured article of claim 1, wherein a ratio of a distance between two adjacent topographical features of the first set of nanostructured topographical features to an average lateral cross-sectional dimension for the first set of nanostructured topographical features is less than or equal to about 5:1.

9. The textured article of claim 1, wherein an average lateral cross-sectional dimension of each set of nanostructured topographical features is less than or equal to about 550 nm.

10. The textured article of claim 1, wherein an average height of each set of nanostructured topographical features is less than or equal to about 550 nm.

11. The textured article of claim 1, wherein a haze of the textured article is less than or equal to about 5 percent.

12. The textured article of claim 1, wherein an optical transmittance of the textured article is greater than or equal to about 92 percent over a visible spectrum of light.

13. The textured article of claim 1, wherein a contact angle between the substrate and water is greater than or equal to about 135 degrees, and wherein a contact angle between the substrate and oleic acid is greater than or equal to about 100 degrees.

14. The textured article of claim 1, wherein an amount of tactilely-transferable residue that is transferred to the textured article is less than or equal to about 1 milligram per tactile contact.

15. The textured article of claim 1, wherein the textured article comprises a portion of a touch-sensitive display screen or cover plate for an electronic device, a non-touch-sensitive component of an electronic device, a surface of a household appliance, or a surface of a vehicle component.

16. The textured article of claim 1, wherein the sets of nanostructured topographical features cover less than or equal to about 0.5 of an area fraction of the surface of the substrate.

17. A method of forming a textured article, the method comprising:
providing a substrate;
disposing and/or creating a first set of nanostructured topographical features on and/or in a surface of the substrate; and
disposing a second set of nanostructured topographical features on the first set of nanostructured topographical features and/or on the surface of the substrate;
wherein the first set of nanostructured topographical features has at least one dimensional attribute different than the second set of nanostructured topographical features.

18. The method of claim 17, wherein disposing a second set of nanostructured topographical features on the first set of nanostructured topographical features and/or on the surface of the substrate comprises glancing angle deposition of the second set of nanostructured topographical features.
